(19) United States
(12) Patent Application Publication
(10) Pub. No.: US 2010/0289891 A1
(43) Pub. Date: Nov. 18, 2010

(54) APPARATUS FOR INSPECTING OBJECT UNDER INSPECTION

(76) Inventor: Yoshihiro Akiyama, Tokyo (JP)

Correspondence Address: LADAS & PARRY LLP, 26 WEST 61ST STREET, NEW YORK, NY, 10023, US

(21) Appl. No.: 12/812,801

(22) PCT Filed: Jan. 14, 2009
(86) PCT No.: PCT/JP2009/000114

§ 371 Date: Jul. 14, 2010

(30) Foreign Application Priority Data
Jan. 15, 2008 (JP) 2008-006227

(51) Int. Cl. H04N 7/18

(52) U.S. Cl. 348/126; 348/E07.085

(57) ABSTRACT

In a board inspection system, a line sensor of a first scanning unit scans, via a telecentric lens, the image of the surface to be inspected on a board, viewed in a perpendicular direction. A line sensor of a second scanning unit scans the image of the surface to be inspected on the board, viewed at an angle, which is tilted toward a first direction by a first angle α from the direction perpendicular to the surface to be inspected. A line sensor of a third scanning unit scans the image of the surface to be inspected on the board, viewed at an angle, which is tilted toward a second direction by a second angle β from the direction perpendicular to the surface to be inspected. A determination unit computes the height of the surface to be inspected on the board with use of image data acquired by a first scanning unit, a second scanning unit, and a third scanning unit.

### TECHNICAL FIELD

The present invention relates to an apparatus for inspecting an object under inspection and particularly to an apparatus for inspecting an object under inspection with use of images of the object under inspection obtained by image capturing.

### BACKGROUND ART

In recent years, electronic boards are mounted on various devices. In devices on which these electronic boards are mounted, miniaturization, thinning, and cost reduction have always been the goal to be achieved. Thus, high-integration design is widely practiced. High-density mounting technology is listed as one of the elements for achieving the high-integration design. Manufacturing technology and inspecting technology are important considerations in the high-density mounting technology. For the inspection of a print board (hereinafter, referred to as a “board”) after components are mounted, inspecting technology exists where an optical image obtained by capturing the image of a print board is used. As such inspecting technology where optical images are used, an automatic inspection system is suggested where the profile of a board is acquired by using a stereo image captured by two camera arrays (for example, see patent document 1).

[Patent document 1] JP 2003-522347

### DISCLOSURE OF INVENTION

### Technical Problem

Electronic components often have legs, and foreign objects often get caught between the legs and boards. Such foreign objects are often very thin (e.g., 0.1 mm), and it is thus required to keep track of the height of the components on boards with high accuracy in order to determine whether or not such foreign objects are caught between them. However, in the technology described in the above patent document, images captured by two camera arrays are greatly affected by parallax. When the parallax has a strong influence, it is difficult to analyze the images to keep track of the heights of the components on the boards, and the accuracy of measuring the heights of the components on the boards may be lowered.

In this background, a purpose of the present invention is to provide an apparatus for inspecting an object under inspection capable of keeping track of the three-dimensional shape of the surface to be inspected on the object under inspection with high speed and with a high degree of accuracy.

### Means for Solving the Problem

An apparatus for inspecting an object under inspection according to one embodiment of the present invention comprises: a first line sensor operative to scan the image of an object under inspection via an optical system that collects a light reflected from the object under inspection, the light being in parallel with the optical axis of a lens and to generate first image data; a second line sensor operative to scan the image of the object under inspection, which is viewed at an angle different from the angle at which the image to be scanned by the first line sensor is viewed, via an optical system that collects a light reflected from the object under inspection, the light being in parallel with the optical axis of a lens and to generate second image data; and a height computation unit operative to compute the height of the surface to be inspected on the object under inspection with use of the first image data and the second image data. According to the embodiment, the three-dimensional shape of the surface to be inspected on the object under inspection can be followed with high speed and with a high degree of accuracy since a stereo image with a small influence of the parallax can be used.

The first line sensor or the second line sensor may scan the image of an object under inspection via a telecentric lens. According to the embodiment, acquiring an image via a telecentric lens with an extremely small angle of view allows for the acquisition of an image with extremely small influence of the parallax.

The first line sensor or the second line sensor may scan the image of an object under inspection via an equal-magnification optical system. According to the embodiment, an image with an extremely small influence of the parallax can be acquired compared to when a reflected light of an object under inspection that has passed through a normal minification optical system is scanned.

The first line sensor may scan the image of the surface to be inspected on an object under inspection viewed in a perpendicular direction. According to the embodiment, the image of the surface to be inspected on the object under inspection viewed in a perpendicular direction can be obtained. Therefore, for example, the range of the blind area can be reduced compared to when all line sensors scan the image of the surface to be inspected on an object under inspection seen from an angle other than a perpendicular direction.

The apparatus for inspecting an object under inspection may further comprise a third line sensor operative to scan, via an optical system that reduces the influence of the parallax, the image of an object under inspection viewed at an angle different from the angles at which the image to be scanned by the first line sensor and by the second line sensor are viewed. According to the embodiment, the range of the blind area for inspection can be reduced compared to when only the first and second line sensors obtain the image of an object under inspection.

The apparatus for inspecting an object under inspection may further comprise a scanning-direction changing means operative to change the direction in which a scanning line for scanning by the first line sensor and the second line sensor faces, with respect to the object under inspection. For example, the components mounted on a board are often arranged side by side in the width direction and the length direction of the board. Changing a main scanning direction with respect to the object under inspection as described above allows for the main scanning direction to be changed with respect to the direction in which the mounted components are lined. Therefore, the main scanning direction with respect to the board can be changed so that lining the mounted components side by side reduces the range of the blind area for inspection.

The scanning-direction changing means may change the direction in which a scanning line faces by 45 degrees with respect to an object under inspection. Scanning an object under inspection such as a board by using a line sensor is generally carried out in the width direction or the length direction of the board. Changing the main scanning direction by 45 degrees as described above allows for a reduction in the range of the blind area for inspection such as an area between components that are mounted side by side in a width direction or in a length direction on the board.

### ADVANTAGEOUS EFFECTS OF INVENTION

According to the apparatus for inspecting an object under inspection according to the present invention, the three-dimensional shape of the surface to be inspected on the object under inspection can be followed with high speed and with a high degree of accuracy.

### BRIEF DESCRIPTION OF DRAWINGS

FIG. 1 is a diagram illustrating the configuration of a board inspection system according to the first embodiment;

FIG. 2 is a perspective view illustrating the internal configuration of an image-capturing unit according to the first embodiment;

FIG. 3 is a schematic diagram illustrating the configuration of the image-capturing unit according to the first embodiment;

FIG. 4 is a diagram illustrating the optical paths of the chief rays of a first scanning unit through a third scanning unit;

FIG. 5 is a top view illustrating an image-capturing unit when the unit is located at the initial position and also when the unit is rotated from the initial position by a rotation mechanism;

FIG. 6 is a functional block diagram of a board inspection system according to the first embodiment;

FIG. 7 is a flowchart illustrating the steps of a board inspection process of the board inspection system according to the first embodiment;

FIG. 8 is a diagram illustrating an image-capturing unit according to the second embodiment; and

FIG. 9 is a diagram illustrating the first scanning unit in a transportation direction.

### EXPLANATION OF REFERENCE

10 board inspection system
14 image-capturing system
24 image-capturing unit
26 rotation mechanism
30 first scanning unit
32 second scanning unit
34 third scanning unit
38 line sensor
40 telecentric lens
70 master PC
74 transportation control unit
76 rotation control unit
78 image-capturing control unit
100 image-capturing unit
102 first scanning unit
104 second scanning unit
106 third scanning unit

### BEST MODE FOR CARRYING OUT THE INVENTION

The embodiment of the present invention (hereinafter, referred to as the “embodiment”) is now described in detail by referring to figures in the following.

### First Embodiment

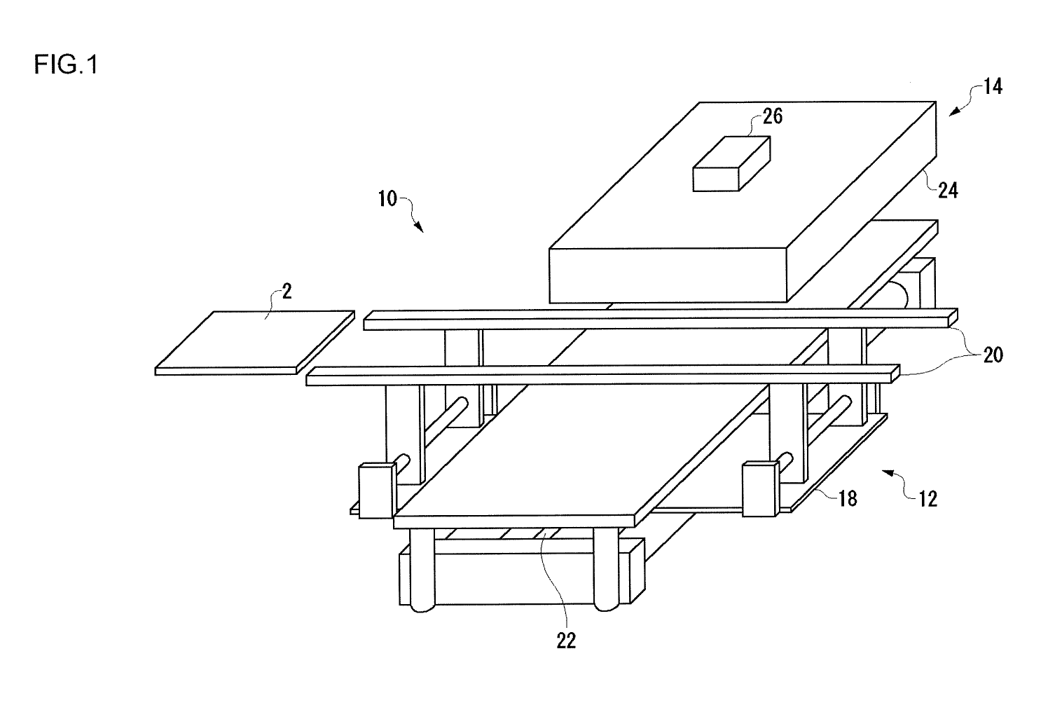

FIG. 1 is a diagram illustrating the configuration of a board inspection system 10 according to the first embodiment. The board inspection system 10 has, for example, a board transportation mechanism 12, an image-capturing system 14, and an image processing unit, a slave PC, and a master PC, which are described hereinafter. The board transportation mechanism 12 has a support plate 18 and two transport rails 20. The transport rails 20 are supported by the support plate 18.

The transport rails 20 have a transport belt (not shown) that transports a board 2 by driving a motor (not shown) and transports a board 2 placed on the transport belt to the approximate center of the board transportation mechanism 12. A transport sensor (not shown) such as an optical sensor that detects the transportation of the board 2 is provided above the transport rails 20 and at the approximate center of an inspection table. Upon the detection, by the transport sensor, of a detection hole provided on the edge surface of the board 2 or on the board 2, the board inspection system 10 determines that the board 2 has been transported to the approximate center of the board transportation mechanism 12 and stops the transportation of the board 2 by the transport rails 20.

A ball screw 22 that extends in the direction orthogonal to the extending direction of the transport rails 20 is provided below the board transportation mechanism 12. The ball screw 22 is driven by a transportation motor (not shown). The rotation of the ball screw 22 moves the board transportation mechanism 12 along with the support plate 18 in the direction perpendicular to the extending direction of the transport rails 20. In this manner, the board inspection system 10 transports the board 2 transported by the transport rails 20 to below the image-capturing system 14.

When the board 2 is moved to a predetermined position, the board inspection system 10 inversely rotates the ball screw 22 by rotating the transportation motor in the opposite direction so as to move the board transportation mechanism 12 to its original position. The board inspection system 10 transports, with use of the transport rails 20, the board 2 that has been transported in this manner so as to proceed to the next step. When there is a board to be subsequently inspected, the board 2 to be subsequently inspected is converted to the approximate center of the board transportation mechanism 12 by using the transport rails 20 again, and the above-described operation is repeated. The transport rail 20 on the near side in the figure is provided with a clamp that corrects the shape of the board 2 by pressing the board 2, which is placed on the transport rails 20, from above. The board 2 transported to the approximate center of the board transportation mechanism 12 is transported to the image-capturing system 14, with the distortion being corrected by the clamp.

The image-capturing system 14 has an image-capturing unit 24 and a rotation mechanism 26. As well as irradiating the board 2 with a light, the image-capturing unit 24 captures the image of the board 2 and generates image data. The rotation mechanism 26 has a unit-rotation motor (not shown) and a speed reduction mechanism (not shown), and the operation of the unit-rotation motor rotates the image-capturing unit 24 around the axis perpendicular to the surface to be inspected on the board 2, via the reduction mechanism.

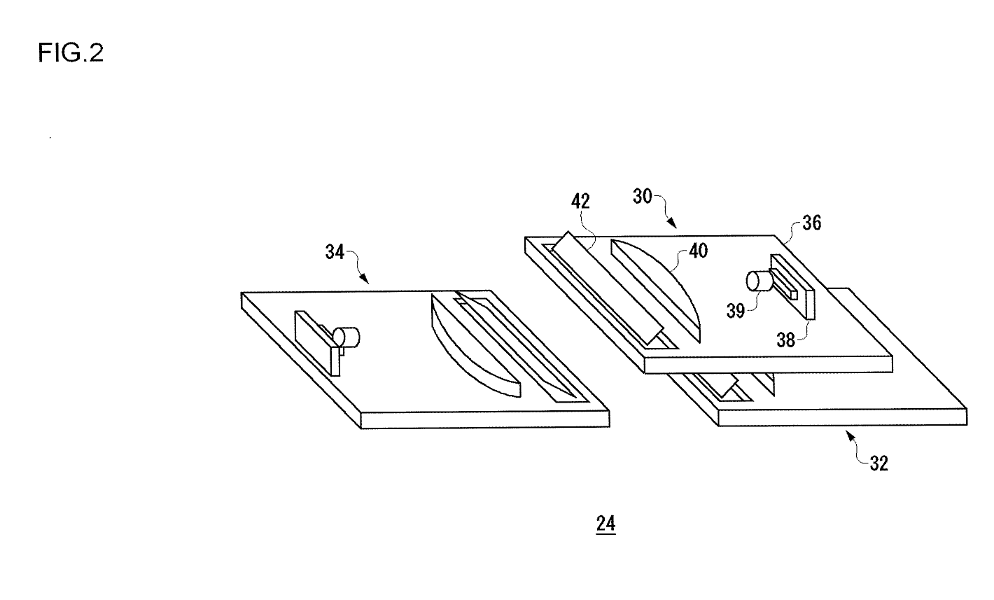

FIG. 2 is a perspective view illustrating the internal configuration of the image-capturing unit 24 according to the first embodiment. The image-capturing unit 24 has a first scanning unit 30, a second scanning unit 32, and a third scanning unit 34. The image-capturing unit 24 has a lighting unit that irradiates the board 2 with a light during image capturing. However, since the configuration of the lighting unit is publicly known, the explanation thereof is omitted. The first scanning unit 30, the second scanning unit 32, and the third scanning unit 34 all have similar configurations, and each scanning unit is provided with a line sensor 38, a lens 39, a telecentric lens 40, and a mirror 42 on a support plate 36. The third scanning unit 34 may be removed for cost-reduction purposes or the like, and the image-capturing unit 24 may be configured with the first scanning unit 30 and the second scanning unit 32.

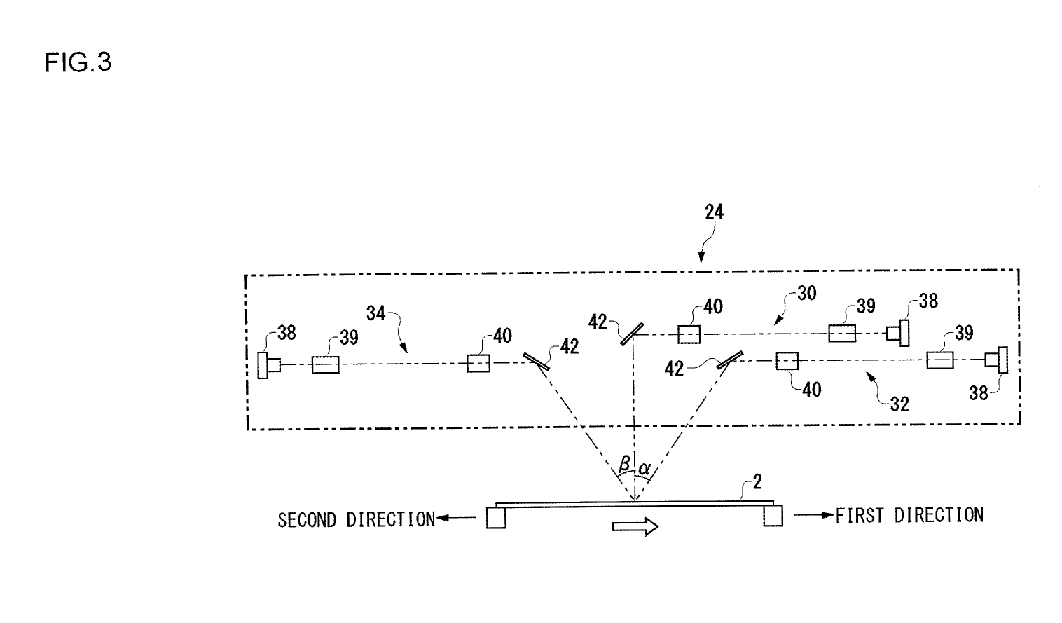

FIG. 3 is a schematic diagram illustrating the configuration of the image-capturing unit 24 according to the first embodiment. In FIG. 3, an image-capturing process of the board 2 is performed by the image-capturing unit 24 while the board 2 is being transported from the left side to the right side. Hereinafter, an explanation is given on the basis that the rightward direction in FIG. 3 is referred to as a first direction and that the leftward direction in FIG. 3 is referred to as a second direction. The image-capturing unit 24 may perform the image-capturing process of the board 2 while the board 2 is transported in the second direction.

Each of the respective line sensors 38 of the first scanning unit 30, the second scanning unit 32, and the third scanning unit 34 scans the image of the board 2 on a scanning line, which is reflected by the mirror 42 and passes through the telecentric lens 40 and the lens 39. In this case, each of the line sensors 38 scans an image on the same scanning line. This allows each of the line sensors 38 to simultaneously scan at the time the scanning line is irradiated with a light, allowing for efficient acquisition of image data.

Hereinafter, an explanation is given on the basis that the position of the image-capturing unit 24 at the time when the scanning line becomes perpendicular to the transportation direction of the board 2 is referred to as an “initial position.” “Scanning” means the operation, which is performed by a light-receiving element inside the line sensor 38, of converting the amount of lights showing the image of a target object into an electrical signal and then outputting the electrical signal. “Image capturing” means to scan one scanning unit. One scanning unit means a scanning unit of the line sensor 38, for example, a single one-way scanning or a single round-trip scanning from one end to the other end of a board.

The line sensor 38 of the first scanning unit 30 scans an image of the surface to be inspected on the board 2, viewed in a perpendicular direction with respect to the surface. The line sensor 38 of the second scanning unit 32 scans an image of the surface to be inspected on the board 2, viewed at the angle, which is tilted toward the first direction by a first angle α from the direction perpendicular to the surface to be inspected. The line sensor 38 of the third scanning unit 34 scans an image of the surface to be inspected on the board 2, viewed at the angle, which is tilted toward the second direction by a second angle β from the direction perpendicular to the surface to be inspected. In the first embodiment, the first angle α and the second angle β are set to be the same angle (both are set to be 10 degrees in the first embodiment). Note that the first angle α and the second angle β may be set to be different angles.

Each of the respective line sensors 38 of the first scanning unit 30, the second scanning unit 32, and the third scanning unit 34 may scan an image on a different scanning line. In this case, each of the line sensors 38 may scan each of images on scanning lines that are parallel to one another.

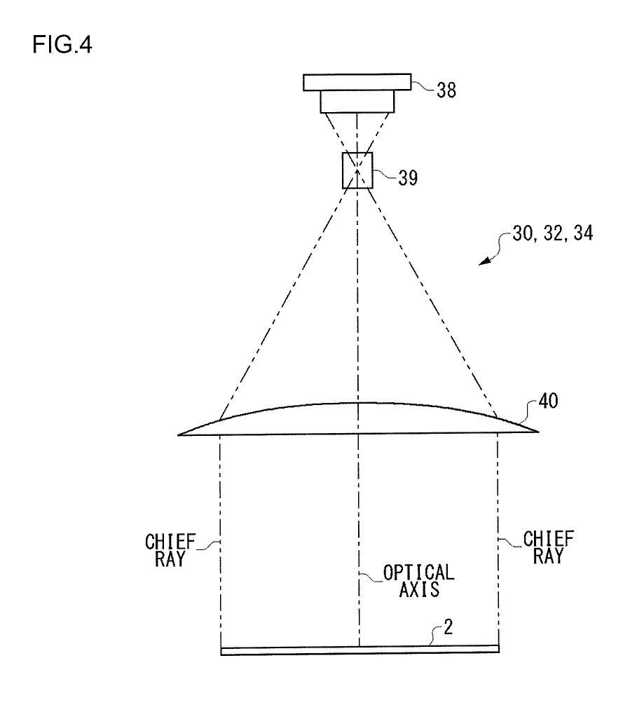

FIG. 4 is a diagram illustrating the optical paths of chief rays of a first scanning unit 30, a second scanning unit 32, and a third scanning unit 34. In FIG. 4, the illustration of the reflection of the chief rays by a mirror 42 is omitted.

The line sensor 38 scans the image of the board 2 via a telecentric lens 40. The telecentric lens 40 collects a light reflected from the board 2, the light being in parallel with the optical axis of the lens. Thus, a chief ray is parallel to the optical axis, in other words, the angle of view is substantially zero degrees, between the telecentric lens 40 and the board 2. When the telecentric lens 40 is used, there is no influence of the parallax regardless of whether a subject image is located at the center of the optical axis or located at a peripheral position away from the optical axis since the angle of view is zero degrees, thus allowing, in principle, for an image to be captured without any distortion caused by parallax. Computation of the height of a component mounted on the board 2 with use of an image with distortion caused due to parallax requires complicated calculation steps in consideration with the distortion caused due to parallax, and it is also difficult to expect a computation result with high accuracy. Using a stereo image without distortion due to parallax as described allows for accurate computation of the height of a component and the like mounted on the board 2 by simple calculation steps.

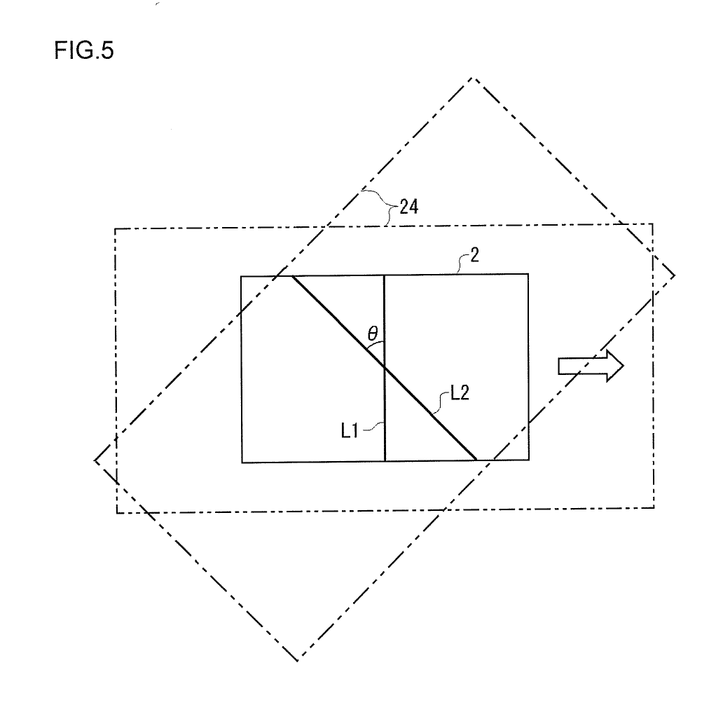

FIG. 5 is a top view illustrating an image-capturing unit 24 when the unit is located at the initial position and also when the unit is rotated from the initial position by a rotation mechanism 26. In FIG. 5, the scanning line on which the first scanning unit 30, the second scanning unit 32, and the third scanning unit 34 scan when the image-capturing unit 24 is located at the initial position is referred to as a first main scanning line L1. The scanning line, when the image-capturing unit 24 is rotated from the initial position, is referred to as a second main scanning line L2. The angle between the first main scanning line L1 and the second main scanning line L2 is the angle of the rotation of the image-capturing unit 24 with respect to the initial position. Hereinafter, the angle is referred to as a scanning angle θ. As described above, the rotation mechanism 26 functions as a scanning-direction changing means that changes the angle between the transportation direction of the board 2 and the scanning line on the board 2. Rotation of the image-capturing unit 24 improves the resolution in the direction, which is orthogonal to the transportation direction of the board 2, (hereinafter, referred to as a “width direction of the board”) by 1/cos θ, allowing for a high-definition image to be captured.

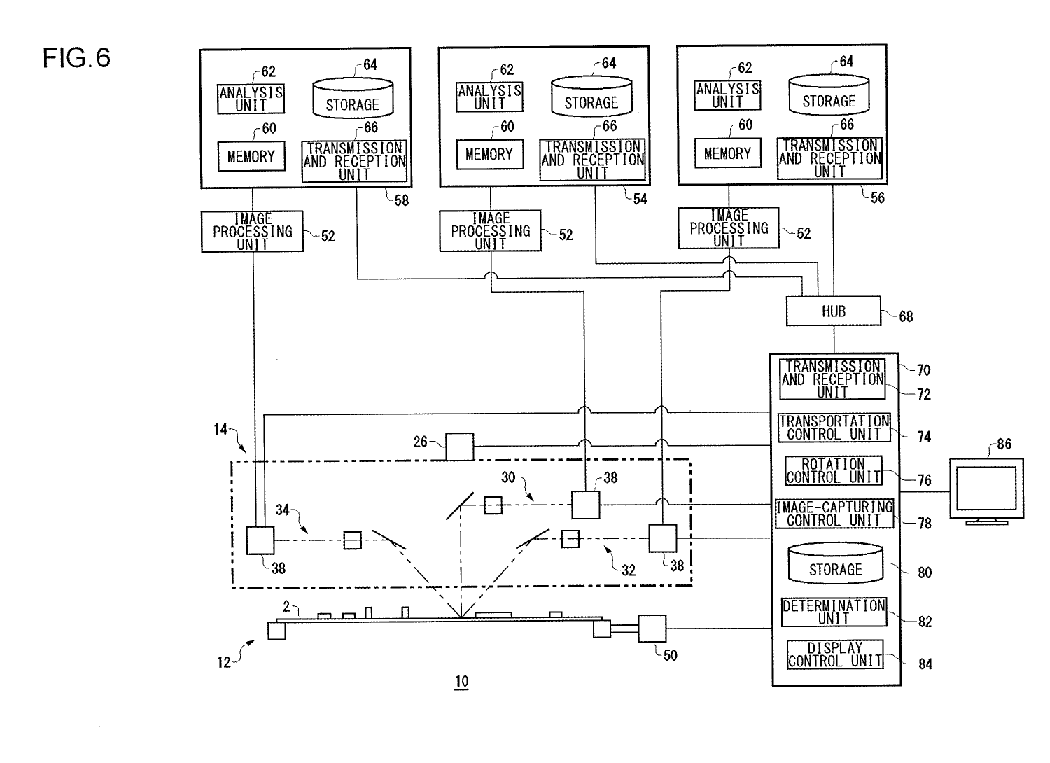

FIG. 6 is a functional block diagram of a board inspection system 10 according to the first embodiment. As shown in FIG. 6, the board inspection system 10 has, in addition to the board transportation mechanism 12 and the image-capturing system 14, a first slave PC 54, a second slave PC 56, a third slave PC 58, a master PC 70, and a display 86. In FIG. 6, regarding the first slave PC 54, the second slave PC 56, the third slave PC 58, and the master PC 70, functional blocks are implemented in hardware components such as a CPU that performs various arithmetic processing, a ROM that stores various control programs, and a RAM that is used as a work area for data storage or program execution and by the cooperation of software components. Thus, there are many ways of accomplishing these functional blocks in various forms in accordance with the components of the combination of hardware and software.

Image data captured and generated by the line sensor 38 of the first scanning unit 30 is output to the first slave PC 54 after image processing performed by an image processing unit 52. Image data captured and generated by the line sensor 38 of the second scanning unit 32 is output to the second slave PC 56 after image processing is performed by the image processing unit 52. Image data captured and generated by the line sensor 38 of the third scanning unit 34 is output to the third slave PC 58 after image processing is performed by the image processing unit 52.

Each of the first slave PC 54, the second slave PC 56, and the third slave PC 58 has a memory 60, an analysis unit 62, a storage 64, and a transmission and reception unit 66. The memory 60 stores received image data.

The analysis unit 62 analyzes the image data stored in the memory 60 and acquires reference data. The reference data means, for example, positional data of a recognition mark, provided on the board 2, that indicates the position of the board 2, identification data such as the serial number or manufacturing date of the board 2 obtained by analyzing an identification mark such as a barcode provided on the board 2, and, besides the image of a component captured by different line sensors 38, data necessary for inspecting the board 2.

The analysis unit 62 analyzes the image data stored in the memory 60 and acquires positional-information data, which indicates the position of each component or a soldered portion mounted on the board 2 by further using the acquired reference data. The storage 64 is configured by a hard disk, and determination-criteria data used for board inspection is stored therein in advance. The analysis unit 62 inspects the mounting condition, which can possibly be inspected in a plane image, of a component of the board 2 by using the determination-criteria data stored in the storage 64. The mounting condition of a component includes the presence of solder, the amount of solder, the presence of a bridge, etc., in addition to, for example, the presence and position of a component such as an element mounted on the board 2, which is an object under inspection, and to whether the component is a right component.

The storage 64 stores a result of inspection as inspection-result data. Each of the first slave PC 54, the second slave PC 56, and the third slave PC 58 transmits the reference data, positional-information data, and the inspection-result data to a master PC 70 via the transmission and reception unit 66 and a hub 68. The first slave PC 54, the second slave PC 56, and the third slave PC 58 transmit the respective images of the board 2 each received to the master PC 70 at this time.

The master PC 70 has a transmission and reception unit 72, a transportation control unit 74, a rotation control unit 76, an image-capturing control unit 78, a storage 80, a determination unit 82, and a display control unit 84. The transmission and reception unit 72 receives the reference data, the positional-information data, and the inspection-result data from the first slave PC 54, the second slave PC 56, and the third slave PC 58. The storage 80 is configured by a hard disk, and these sets of data received are stored in the storage 80.

A transportation motor 50 that transports the board 2 in the first direction and in the second direction is connected to the master PC 70. The transportation control unit 74 transports the board transportation mechanism 12 by activating the transportation motor 50 by supplying a drive signal to the transportation motor 50 so as to transport the board 2 in the first direction and in the second direction. Therefore, the transportation control unit 74 and the board transportation mechanism 12 function as a transportation means of transporting the board 2.

A unit-rotation motor provided inside the rotation mechanism 26 is connected to the master PC 70. The rotation control unit 76 controls the angle of rotation of the image-capturing unit 24 by controlling the drive signal to be supplied to the unit-rotation motor.

Each of the respective line sensors 38 of the first scanning unit 30, the second scanning unit 32, and the third scanning unit 34 is connected to the master PC 70. The image-capturing control unit 78 controls image capturing of the line sensors 38 so that the image of the board 2 is scanned at the time when the lighting unit irradiates the board 2 with a light.

The determination unit 82 computes the height of a component mounted on the board 2 by using the reference data and the positional-information data received from the first slave PC 54, the second slave PC 56, and the third slave PC 58. Thus, the determination unit 82 functions as a height computation unit.

More specifically, since the first scanning unit 30, the second scanning unit 32, and the third scanning unit 34 scan the surface to be inspected on the board 2 seen from respectively different points of view, a part having a height indicates that the respective position of the images obtained by scanning units are different from one another when the plane of the surface to be inspected has zero height. Since the angles of the respective points of view on a slant when the second scanning unit 32 and the third scanning unit 34 scan are determined in advance, the determination unit 82 computes the height of a component mounted on the board 2 based on respective shift lengths of component positions indicated by each of the sets of the positional-information data received from the first slave PC 54, the second slave PC 56, and the third slave PC 58, respectively. In the storage inspection reference data regarding the height of a component on the surface to be inspected on the board 2 and the like is stored in advance. The determination unit 82 performs, for example, defect determination for determining whether or not the height of a component is within the normal range indicated by the inspection reference data, by using the inspection reference data stored in the storage 80. For example, this allows for detection of whether a foreign object is caught between a leg of an electronic component and a board. The determination unit 82 may acquire the reference data and the positional-information data by using the images received from the first slave PC 54, the second slave PC 56, and the third slave PC 58.

The display control unit 84 displays an inspection result, which includes a result of a defect determination, of the board 2 provided by the determination unit 82 and an inspection result of the board 2 indicated by the received inspection-result data on the display 86. The display control unit 84 may, for example, display the image viewed as an aerial view perpendicular to the board 2, which is received from the first slave PC 54, on the display 86 while specifying the position of a component with a defect.

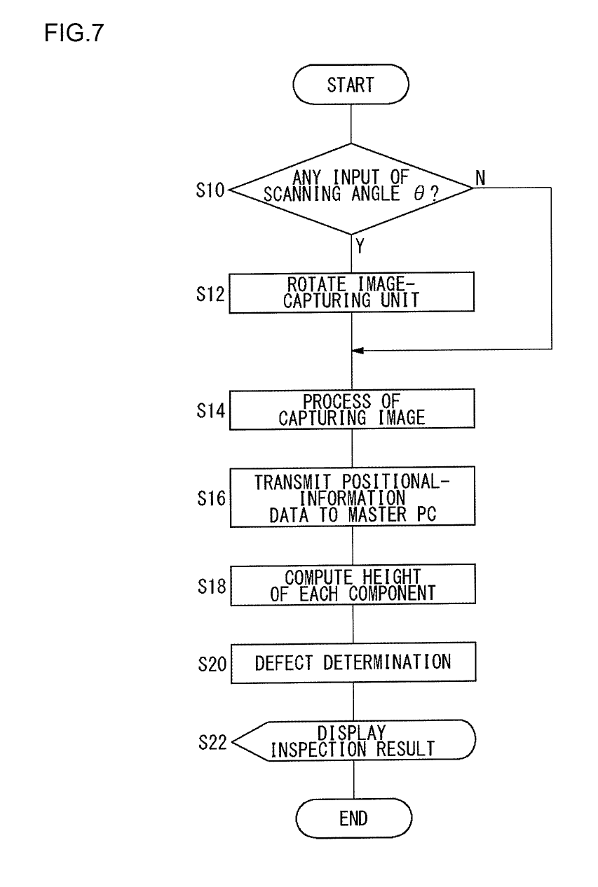

FIG. 7 is a flowchart illustrating the steps of a board inspection process of the board inspection system 10 according to the first embodiment. The push of a start button, which is provided on the board inspection system 10, by a user starts the process of the flowchart.

The user can input a scanning angle θ to the master PC 70 by using an input apparatus such as a mouse or a keyboard. Information indicating the scanning angle θ input by the user is stored in a RAM of the master PC 70. When the start button is pushed by the user, the rotation control unit 76 determines, by referring to the RAM, whether or not a scanning angle θ is input by the user (S10). When a scanning angle θ is already input (Y in S10), the rotation control unit 76 provides a drive signal to a unit-rotation motor of the rotation mechanism 26 so as to rotate the image-capturing unit 24 from its initial position by the scanning angle θ

(S12). When no scanning angle θ is input (N in S10), the rotation control unit 76 skips the process of step S12.

The user may be able to select whether or not the direction in which the scanning line faces is changed with respect to the board 2 by entering an input to the master PC 70 with use of an input apparatus such as a mouse or a keyboard. When the user selects to change the direction in which the scanning line faces, the information indicating that the user has selected to change the direction is stored in a RAM of the master PC 70. When the start button is pushed by the user, the rotation control unit 76 determines, by referring to the RAM, whether or not the direction in which the scanning line faces is selected, by the user, to be changed. When the direction is selected to be changed, the rotation control unit 76 rotates the image-capturing unit 24 from its initial position by 45 degrees so as to change the direction in which the scanning line faces by 45 degrees with respect to the board 2. This allows for a reduction in the range of the blind area for inspection such as an area between components that are mounted side by side in a width direction or in a length direction on the board 2.

The image-capturing control unit 78 then performs a process of capturing the image of the board (S14). In the process of capturing the image of the board, the transportation control unit 74 transports the board 2 in the first direction, and the image-capturing control unit 78 allows the line sensor 38 to start capturing the image of the board 2 when the board 2 is transported in the first direction. The transportation control unit 74 transports, in reference to the RAM, the board 2 so that an interval between scanning lines in the transportation direction is L*cos θ. L represents the interval between the scanning lines on the surface to be inspected on the board 2 when the board 2 is located at its initial position. In comparison to when the board 2 is located in its initial position, this allows for the resolution, in the transportation direction, to be improved to 1/cos θ. When the scanning angle θ is provided, the resolution in the width direction of the board becomes 1/cos θ as described above. Adjusting the transportation speed as described above allows the resolution in the transportation direction to correspond to the resolution in the width direction of the board.

Upon the completion of the process of capturing the image of the board, the respective analysis units 62 of the first slave PC 54, the second slave PC 56, and the third slave PC 58 analyze the acquired image data and acquire the positional-information data and the like as described above. The transmission and reception unit 66 transmits the acquired positional-information data and the like to the master PC 70 (S16). The determination unit 82 computes the height of each component on the surface to be inspected on the board 2 by using the received positional-information data and the like (S18) and performs the defect determination of the board 2 based on the computed height (S20). Upon the completion of the defect determination, the display control unit 84 displays the result of the inspection of the board 2 on the display 86 (S22) and completes the process in the flowchart.

### Second Embodiment

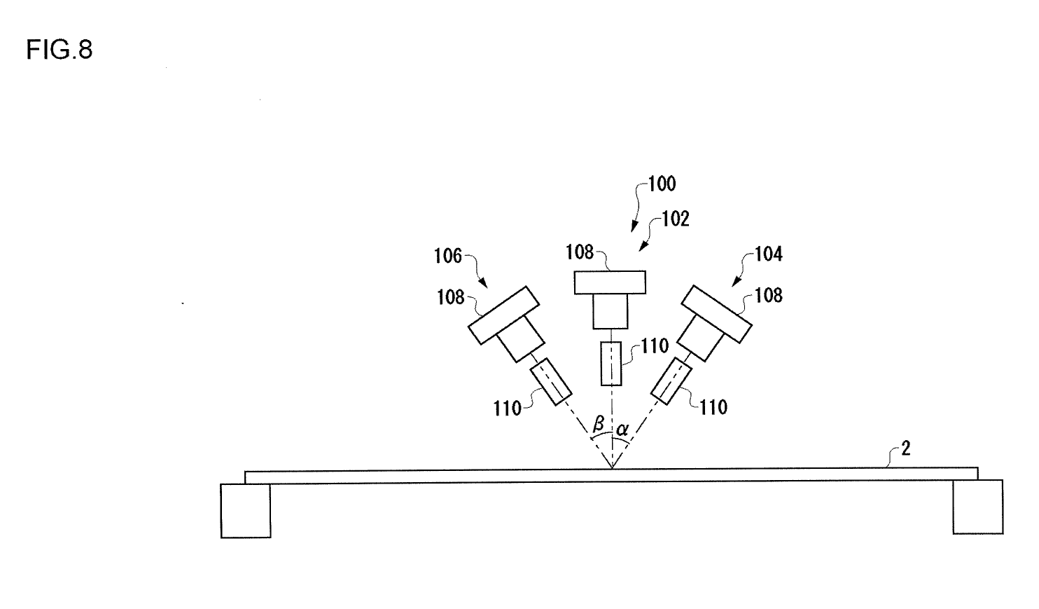

FIG. 8 is a diagram illustrating an image-capturing unit 100 according to the second embodiment. The configuration of a board inspection system according to the second embodiment is similar to the board inspection system 10 according to the first embodiment except that an image-capturing unit 100 instead of the image-capturing unit 24 is provide in the board inspection system according to the second embodiment. Therefore, in the second embodiment, the rotation mechanism 26 rotates the image-capturing unit 100 around the axis perpendicular to the surface to be inspected on the board 2.

The image-capturing unit 100 has a first scanning unit 102, a second scanning unit 104, and a third scanning unit 106. The first scanning unit 102, the second scanning unit 104, and the third scanning unit 106 each have a line sensor 108 and a lens array 110. The third scanning unit 106 may be removed for cost-reduction purposes or the like, and the image-capturing unit 100 may be configured with the first scanning unit 102 and the second scanning unit 104.

Each of the respective line sensors 108 of the first scanning unit 102, the second scanning unit 104, and the third scanning unit 106 scans an image on the same scanning line in the surface to be inspected on the board 2. In the second embodiment, the position of the image-capturing unit 100 at the time when the scanning line becomes perpendicular to the transportation direction of the board 2 is also referred to as an “initial position.” Each of the respective line sensors 108 of the first scanning unit 102, the second scanning unit 104, and the third scanning unit 106 may scan an image on a different scanning line. In this case, each of the line sensors 38 may scan each of images on scanning lines that are parallel to one another.

The line sensor 108 of the first scanning unit 102 scans an image of the surface to be inspected seen in a perpendicular direction. The line sensor 108 of the second scanning unit 104 scans an image of the board 2 seen from the angle, which is tilted toward the first direction by the first angle α from the direction perpendicular to the surface to be inspected. The line sensor 108 of the third scanning unit 106 scans an image of the board 2 seen from the angle, which is tilted toward the second direction by the second angle β from the direction perpendicular to the surface to be inspected. In the second embodiment, the first angle α and the second angle β are set to be the same angle (both are set to be 10 degrees in the second embodiment). Note that the first angle α and the second angle β may be set to be different angles.

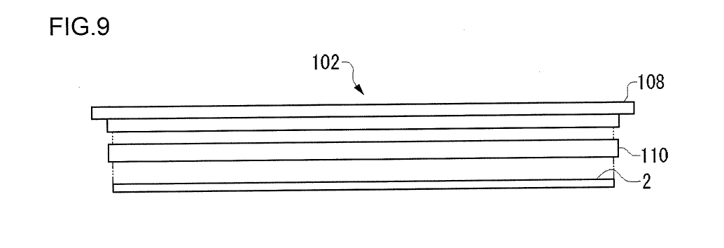

FIG. 9 is a diagram illustrating the first scanning unit 102 in a transportation direction. Since the configuration of the second scanning unit 104 and the configuration of the third scanning unit 106 are similar to that of the first scanning unit 102, the explanation of the configuration of the second scanning unit 104 and the configuration of the third scanning unit 106 is omitted by explaining the configuration of the first scanning unit 102.

The lens array 110 is a so-called equal-magnification optical system and is configured as a rod lens array in which micro-miniature rod lenses are arranged. Since the configuration of a rod lens array is publicly known, the explanation thereof is omitted. The line sensor 108 is configured with light-receiving elements arranged in a line along the length that corresponds to the entire area in the width direction of the board 2. The line sensor 108 scans the image of the surface to be inspected on the board 2, via the lens array 110.

The equal-magnification optical system also collects a light reflected from the board 2, the light being substantially in parallel with the optical axis of the lens. Therefore, employing the equal-magnification optical system as described above allows for the influence of the parallax to be greatly reduced on the image of the board 2 acquired by the line sensor 108. In the second embodiment, since the equal-magnification optical system is employed in all of the first scanning unit 102, the second scanning unit 104, and the third scanning unit 106, an image scanned from a different angle can be acquired in a condition where the influence of the parallax is small. Therefore, the three-dimensional shape of the surface to be inspected on the board 2 can be followed with high speed and with a high degree of accuracy.

As the lens array 110, a Selfoc (registered trademark) lens array (SLA) may be employed. Since such a lens array has a very short focal distance, the lens array needs to be placed at a close range of 5-10 millimeters from the surface to be inspected on the board 2. Therefore, the lens array cannot be used for the inspection of the board 2 on which a tall component is mounted. In addition, there is interference by an adjacent lens when such a lens array is used, limiting the resolution to be, at most, 40-50 microns (micrometers).

Not only the aforementioned embodiment but the combinations of the elements of the embodiments will also be within the scope of the present invention. Various variations including design variations can be made to the embodiments by those skilled in the art and such variations are also within the scope of the present invention. Some such examples are shown in the following.

In an exemplary variation, a user can input to the master PC 70 whether or not to perform the inspection of the height of the surface to be inspected on the board 2, by using, for example, a mouse or a keyboard. When a board inspection in which the height of the surface to be inspected on the board 2 is not performed is selected by a user, the image-capturing control unit 78 does not capture the image of the board 2 by using the second scanning unit 32 and the third scanning unit 34 but captures the image of the board 2 by using only the first scanning unit 30 in the first embodiment. In the second embodiment, the image-capturing control unit 78 does not capture the image of the board 2 by using the second scanning unit 104 and the third scanning unit 106 but captures the image of the board 2 by using only the first scanning unit 102. Allowing a user to be able to select the inspection of the height of the surface to be inspected on the board 2 as described above can reduce a load in an inspection process in the second slave PC 56, the third slave PC 58, and the master PC 70.

Even when the image of the board 2 is captured only by the first scanning unit 30, the rotation control unit 76 rotates, by a scanning angle θ, the image-capturing unit 24 in the first embodiment and rotates the image-capturing unit 100 in the second embodiment when the scanning angle θ is input by a user. This allows for the image of the board 2 to be captured with a resolution higher than that when the image-capturing unit 24 or the image-capturing unit 100 capture the image of the board 2 while the unit is at its initial position.

In another exemplary variation, a turntable is provided on the transport rail 20. The turntable is configured so as to be rotated by the activation of a motor. When the start button is pressed after the scanning angle θ is input to the master PC 70 by a user, the rotation control unit 76 rotates the turntable by the scanning angle θ by activating the motor. Rotating the board 2 instead of rotating the image-capturing unit 24 or the image-capturing unit 100 as described above also allows for the scanning angle θ to be changed.

In another exemplary variation, the image-capturing unit 24 or the image-capturing unit 100 is fixed at a position where the scanning angle θ becomes at least zero. The scanning angle θ may be 45 degrees in this case. Fixing the direction in which a scanning line faces in advance at a tilt with respect to the transportation direction of the board 2 allows for a reduction of the cost of a mechanism used for rotating the image-capturing unit 24 or the image-capturing unit 100 or a reduction in the time required for rotating the image-capturing unit 24 or the image-capturing unit 100.

### INDUSTRIAL APPLICABILITY

According to the apparatus for inspecting an object under inspection according to the present invention, the three-dimensional shape of the surface to be inspected on the object under inspection can be followed with high speed and with a high degree of accuracy.

1. An apparatus for inspecting an object under inspection comprising:
a first line sensor operative to scan the image of an object under inspection via an optical system that collects a light reflected from the object under inspection, the light being in parallel with the optical axis of a lens and to generate first image data;
a second line sensor operative to scan the image of the object under inspection, from an angle different from the angle viewed by the first line sensor with respect to the surface to be inspected, on the same scanning line as that of the first line sensor via an optical system that collects a light reflected from the object under inspection, the light being in parallel with the optical axis of a lens and to generate second image data; and
a height computation unit operative to compute the height of the surface to be inspected on the object under inspection with use of the first image data and the second image data.

2. The apparatus for inspecting an object under inspection according to claim 1, wherein the first line sensor or the second line sensor scans the image of an object under inspection via a telecentric lens.

3. The apparatus for inspecting an object under inspection according to claim 1, wherein the first line sensor or the second line sensor scans the image of an object under inspection via an equal-magnification optical system.

4. The apparatus for inspecting an object under inspection according to claim 1 wherein the first line sensor scans the image of the surface to be inspected on an object under inspection seen in a perpendicular direction.

5. The apparatus for inspecting an object under inspection according to claim 4 further comprising a third line sensor operative to scan, via an optical system that reduces the influence of the parallax, the image of an object under inspection viewed at an angle different from the angles at which the image to be scanned by the first line sensor and by the second line sensor are viewed.

6. The apparatus for inspecting an object under inspection according to claim 1 further comprising a scanning-direction changing means operative to change a scanning line for scanning by the first line sensor and the second line sensor with respect to the object under inspection.

7. The apparatus for inspecting an object under inspection according to claim 6 wherein the scanning-direction changing means changes the direction in which a scanning line faces by 45 degrees with respect to an object under inspection.
